(19) United States
(12) Patent Application Publication
(10) Pub. No.: US 2007/0232401 A1
(43) Pub. Date: Oct. 4, 2007

(54) Method and device for displaying pictures and appealing shapes for electronic game devices and accessories thereof

(76) Inventor: Michael Kidakarn, Gardena, CA (US)

Correspondence Address: Raymond Y. Chan, 108 N. Ynez Ave., #128, Monterey Park, CA, 91754, US

(21) Appl. No.: 11/398,298

(22) Filed: Apr. 4, 2006

(51) Int. Cl. A63F 13/00

(52) U.S. Cl. 463/46

(57) ABSTRACT

A detachable face for an electronic game device having an engaging side includes a detachable frame and a see-through protective shelter. The detachable frame has a coupling side adapted for detachably coupling with the engaging side of the electronic game device, and an opposed picture retention side adapted for holding a picture frame in position. The see-through protective shelter is detachably mounted at the picture retention side of the detachable frame to form a picture compartment between the protective shelter and the detachable frame for receiving the picture frame so as to allow the picture frame from being seen through the protective shelter, in such a manner that the detachable face is adapted for creating a visual effect of the electronic game via the picture frame as a decorative element and for enhancing an aesthetic appearance of the electronic game device by selectively interchanging the picture frame.

### BACKGROUND OF THE PRESENT INVENTION

1. Field of Invention

The present invention relates to a game device, and more particularly to a method and device for displaying pictures and appealing shapes for an electronic game device, so as to impart an enhanced visual effect of that electronic game device.

2. Description of Related Arts

A conventional electronic game device, such as an XBOX game system, comprises a main console adapted for connecting to a television set, and at least one game controller connected to the main console for inputting commands when a particular game is launched by the main console. When a user wishes to a particular game, he/she may insert a particular game CD or DVD into the main console, which then loads the data stored in the game CD or DVD for launching that particular game. The user is then able to control an operation of the game through the game controller.

As a matter of convention arts, the majority of electronic game devices, such as XBOX game systems and Playstation2 game systems, their main consoles have a pre-designed aesthetics appearance. For example, it is well-known that the XBOX main console has a predetermined black color.

Therefore, a disadvantage of conventional electronic game devices is that the main console has no flexibility at all to match with the up-to-date fashion. Thus, the user will lose interests to the main console soon after he/she has got the game system. Thereafter, the main console will become no more than a CD or DVD player without any contribution to the user's excitement when he or she is playing games.

Moreover, a particular game system is usually meant to support launching many games developed over a period of time. For example, Xbox and Playstatation2 game systems have been in the market for several years. During their product cycles, a lot of games have been developed in accordance with market demands. This means that popularity of particular games changes over time. The consequence is that users of the electronic game devices may wish from time to time to change or to alter the appearance of their main consoles in accordance with the most up-to-date fashion. However, for conventional electronic game devices, the most a user can do for this purpose is to utilize some sorts of stickers for temporarily adding some sort of external decoration to the main console. The obvious problem for this practice is that every time when the user wishes to update or charge the appearance of the main console, he or she has to remove the old stickers and put a new one. Moreover, when too many stickers are attached onto the main console, the ultimate aesthetic appearance thereof may not be optimal.

### SUMMARY OF THE PRESENT INVENTION

A main object of the present invention is to provide a detachable face for an electronic game device, so as to impart an enhanced visual effect of the electronic game device.

Another object of the present invention is to provide a detachable face for an electronic game device, which comprises a detachable frame supporting a picture frame and being detachably attached on a front engaging side of a main console of the electronic game device, so as to create a visual effect of the electronic game via the picture frame as a decorative element. In other words, the user of the present invention is allowed to pick particular picture frames with respect to a particular fashion or game, so as to give the game console with the most up-to-date response to games trend.

Another object of the present invention is to provide a detachable face for an electronic game device, wherein the picture frame is sufficiently protected by a see-through protective shelter so as to allow durable and secure display of the picture frame until the user replaces it.

Another object of the present invention is to provide a detachable face for an electronic game device, wherein the picture frame can be conveniently tailor-made to fit a user's demand, so that when the electronic game device changes owner, the picture frame can be easily replaced with another tailor-made picture frame to fulfill the need of the new owner.

Another object of the present invention is to provide a detachable face for an electronic game device, which is capable of providing, apart from the optimal graphical pattern provided on the picture frame, additional entertainment effect such as illuminating effect, so as to maximize excitement sentiment when the user plays with the electronic game device.

Another object of the present invention is to provide a detachable face for an electronic game device, which does not affect the normal operation of the electronic game device, so as to facilitate widespread application of the present invention.

Another object of the present invention is to provide a method of displaying interchangeable pictures for an electronic game device by using a detachable face.

Accordingly, in order to accomplish the above objects, the present invention provides a detachable face for an electronic game device having an engaging side, comprising:

a detachable frame having a coupling side adapted for detachably coupling with the engaging side of the electronic game device, and an opposed picture retention side adapted for holding a picture frame in position; and

a see-through protective shelter detachably mounted at the picture retention side of the detachable frame to form a picture compartment between the protective shelter and the detachable frame for receiving the picture frame so as to allow the picture frame from being seen through the protective shelter, in such a manner that the detachable face is adapted for creating a visual effect of the electronic game via the picture frame as a decorative element and for enhancing an aesthetic appearance of the electronic game device by selectively interchanging the picture frame.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a detachable face for an electronic game device according to a preferred embodiment of the present invention.

FIG. 2 is an exploded perspective view of the detachable face for an electronic game device according to the above preferred embodiment of the present invention.

FIG. 3 is a schematic diagram of the use of the detachable face for an electronic game device according to the above preferred embodiment of the present invention.

FIG. 4 is a method of displaying pictures for an electronic game device by the detachable face according to the above preferred embodiment of the present invention.

### DETAILED DESCRIPTION OF THE PREFERRED EMBODIMENT

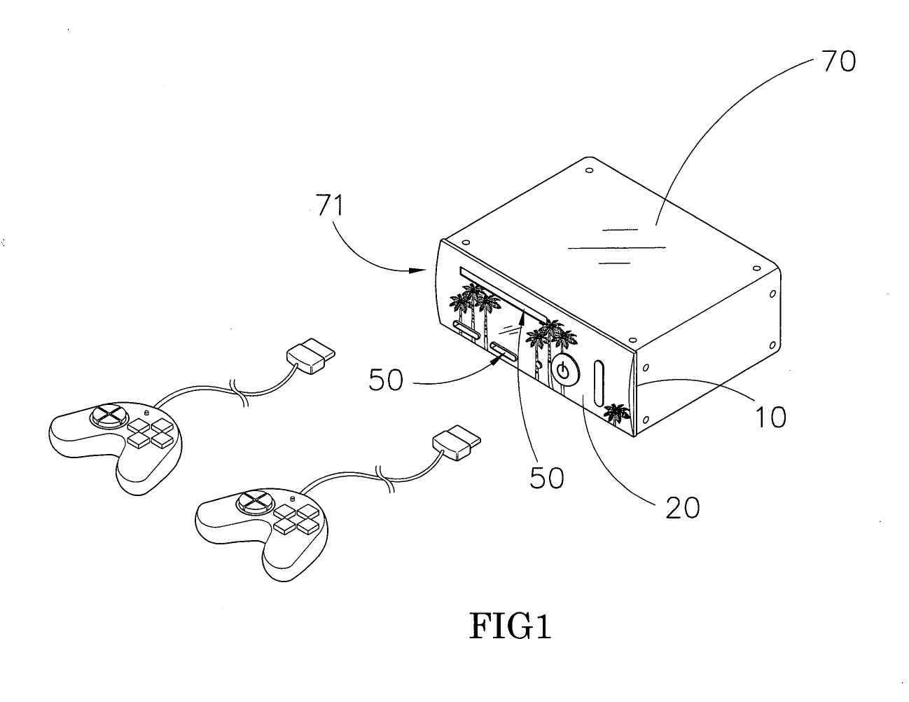

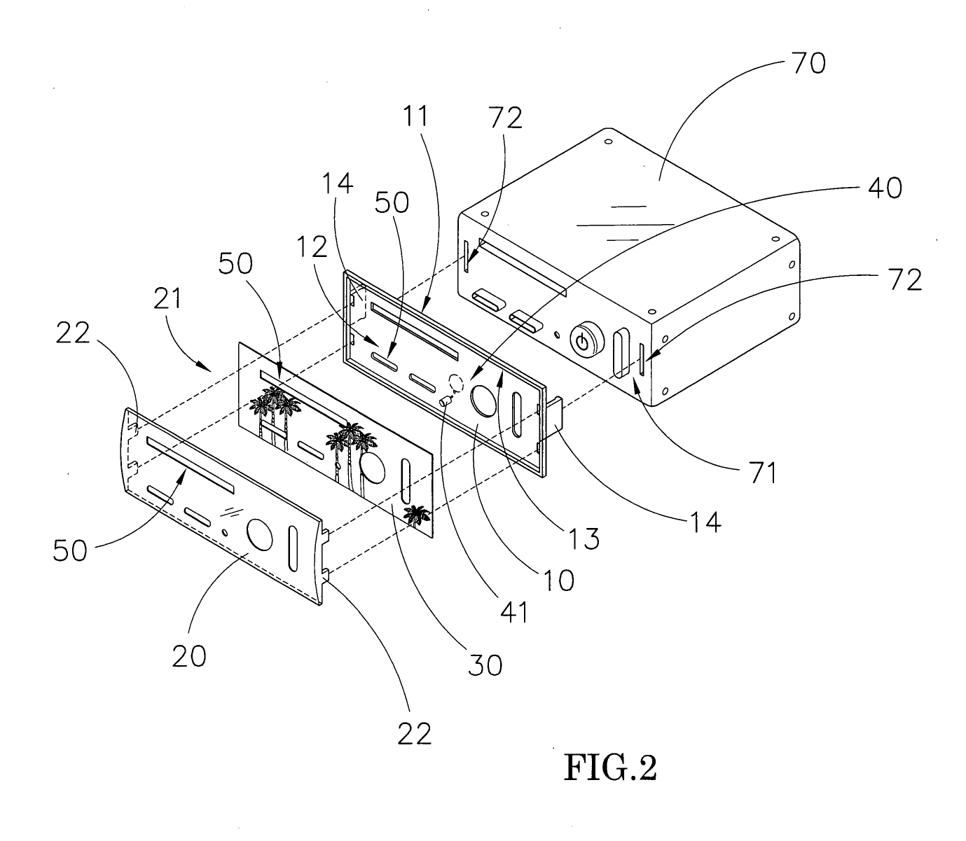

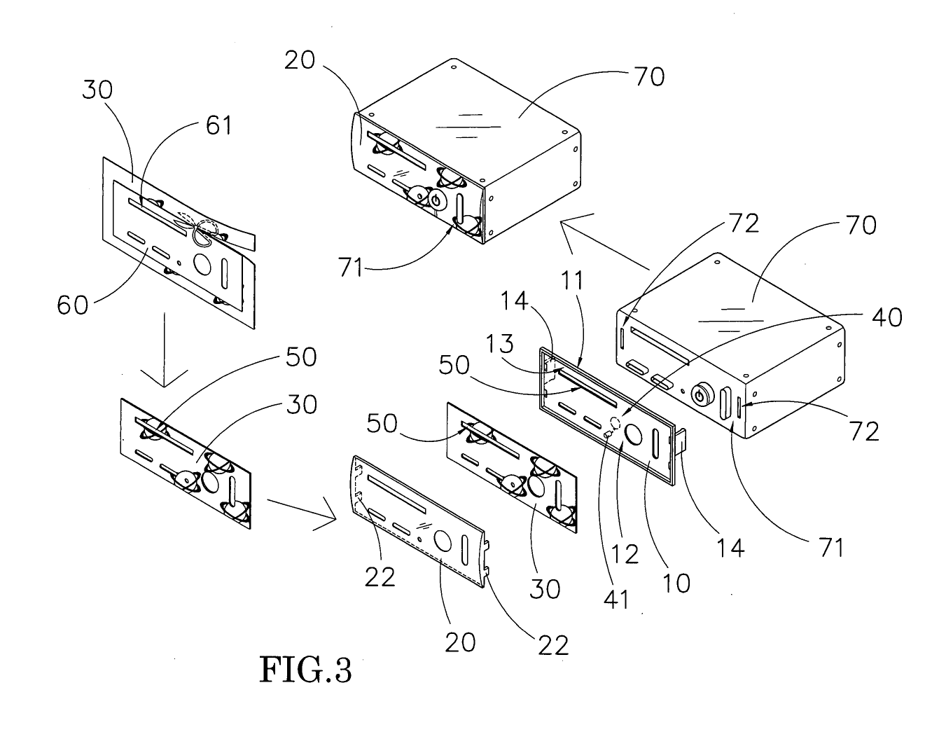

Referring to FIG. 1 to FIG. 3 of the drawings, a detachable face for an electronic game device 70 having an engaging side 71 according to a preferred embodiment of the present invention is illustrated; in which the detachable face comprises a detachable frame 10, and a see-through protective shelter 20.

The detachable frame 10 has a coupling side 11 adapted for detachably coupling with the engaging side 71 of the electronic game device 70, and an opposed picture retention side 12 adapted for holding a picture frame 30 in position.

The see-through protective shelter 20 is detachably mounted at the picture retention side 12 of the detachable frame 10 to form a picture compartment 21 between the protective shelter 20 and the detachable frame 10 for receiving the picture frame 30 so as to allow the picture frame 30 from being seen through the protective shelter 20, in such a manner that the detachable face is adapted for creating a visual effect of the electronic game via the picture frame 30 as a decorative element and for enhancing an aesthetic appearance of the electronic game device 70 by selectively interchanging the picture frame 30.

According to the preferred embodiment of the present invention, the detachable frame 10 further has an engagement rim 13 indently formed on the picture retention side 12 thereof to define a retention cavity on the picture retention side 12, wherein the see-through protective shelter 20 is adapted to enclose the retention cavity for forming the picture compartment 21 of the see-through protective shelter 20. Accordingly, the picture frame 30 is shaped and sized to fittedly receive into the picture compartment 21 for enhancing an aesthetic appearance of the electronic game device 70, and the see-through protective shelter 20 is detachably mounted on the picture retention side 12 of the detachable frame 10 to enclose the retention cavity for sealing the picture frame 30 therein.

Moreover, the detachable frame 10 further comprises at least one (preferably two) engaging member 14 rearwardly extended from the coupling side 11 of the detachable frame 10 for mounting on the engaging side 71 of the electronic game device 70. Accordingly, the electronic game device 70 should contain a corresponding number of engagement slots 72 formed on the engaging side 71 to substantially align with the engaging member 14 of the detachable frame 10 so that the detachable frame 10 is capable of detachably mounting on the electronic game device 70 via the detachable engagement between the engaging member 14 and the engagement slot 72.

On the other hand, the see-through protective shelter 20 further comprises a plurality of retention members 22 rearwardly extended from a peripheral side edge of the see-through protective shelter 20 for detachably engaging with the engagement rim 13 of the detachable frame 10 so as to form the picture compartment 21, wherein the picture frame 30 is sandwiched between the detachable frame 10 and the see-through protective shelter 20 within the picture compartment 21.

It is worth mentioning that the see-through protective shelter 20 is made of translucent materials have a predetermined light transmissivity for allowing the user to see the aesthetic patterns formed on the picture frame 30 via the see-through protective shelter 20. Moreover, this protective shelter 20 also serves to physically isolate the picture frame 30 from external environment so as to substantially protect the picture frame 30 from accidental damage. Consequently, when the aesthetic pattern of the picture frame 30 is classical or has become collectibles, the picture frame 30 is perfectly protected to retain an optimal condition thereof.

In order to enhance the visual effect of the electronic game device 70 and visual recognition of the picture frame 30, the detachable face of the present invention further comprises a lighting arrangement 40 mounted thereon for providing illumination to the picture frame 30 so as to illuminate the aesthetic pattern. More specifically, the lighting arrangement 40 comprises at least one illuminating unit 41 spacedly mounted within the picture compartment 21 for providing illumination to the picture compartment 21 for illuminating the picture frame 30. Accordingly, the picture frame 30 is preferably embodied as being manufactured by translucent materials as well so as to allow the light illuminated from the lighting arrangement 40 to pass through the picture frame 30 and highlight the aesthetic pattern thereof. Alternatively, the picture frame 30 may be embodied as a photograph having a desired aesthetic pattern formed thereon.

It is important to point out that the detachable face further has a plurality of accessing slots 50 formed on the detachable frame 10, the picture frame 30 and the see-through protective shelter 20, wherein the accessing slots 50 formed on either the detachable frame 10, the picture frame 30 and the see-through protective shelter 20 are aligned with the corresponding accessing slots 50 formed on the picture frame 30 and the see-through protective shelter 20, wherein the accessing slots 50 for each of the detachable frame 10, the see-through protective shelter 20 and the picture frame 30 are adapted for aligning with such operation elements as the disc platform, the controller slots, and control panel of the electronic game device 70, so that the user is able to access the disc platform, the controller slots and the control panel even of the detachable face is mounted on the engaging side 71 of the electronic game device 70.

The picture frame 30 is tailored-made to suit individual needs, and is replaceable by detaching the see-through protective shelter 30 from the electronic game device 70. In order to guide the user for making the picture frame 30, the detachable face further comprises a frame guider 60 adapted for guiding a user of the present invention to cut the picture frame 30 into a desirable size and aesthetic appearance, wherein the resulting picture frame 30 has the corresponding accessing slots 50 formed thereon for aligning with the accessing slots 50 formed on the detachable frame 10 and the see-through protective shelter 20.

In other words, the frame guider 60 is shaped and sized corresponding to the detachable frame 10 for guiding a user to cut the picture frame into a desirable size with respect to the detachable frame 10, wherein the frame guider 60 has a plurality of guiding slots 61 aligning with the accessing slots 50 respectively for guiding the user to form a plurality of through slots as the accessing slots 50 on the picture frame 30 so as to incorporate the picture frame 30 with the detachable face.

It is worth mentioning that the picture frames 30 may also be pre-cut into a size and shape corresponding to the detachable frame 10 to fit into the picture compartment 21, wherein each of the picture frames 30 has a plurality of through slots 31 aligning with the accessing slots 50 respectively for allowing the user accessing the operation elements of the electronic game device 70 when the detachable face is mounted thereto.

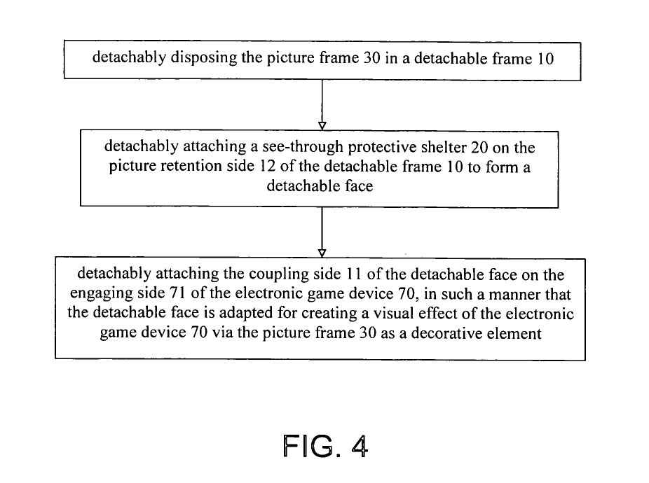

Referring to FIG. 4 of the drawings, a method of detachably displaying pictures on an electronic game device 70 which has an engaging side 71 according to the preferred embodiment of the present invention is illustrated, in which the method comprises the steps of:

(a) detachably disposing the picture frame 30 in a detachable frame 10, wherein the detachable frame 10 has a coupling side 11 adapted for detachably coupling with the engaging side 71 of the electronic game device 70 and an opposed picture retention side 12 adapted for holding the picture frame 10 in position;

(b) detachably attaching a see-through protective shelter 20 on the picture retention side 12 of the detachable frame 10 to form a detachable face, wherein a picture compartment 21 is formed between the protective shelter 20 and the detachable frame 10 to sealedly receive the picture frame 30 in the picture compartment 21 so as to allow the picture frame 30 from being seen through the protective shelter 20; and

(c) detachably attaching the coupling side 11 of the detachable face on the engaging side 71 of the electronic game device 70, in such a manner that the detachable face is adapted for creating a visual effect of the electronic game device 70 via the picture frame 30 as a decorative element and for enhancing an aesthetic appearance of the electronic game device 70 by selectively interchanging the picture frame 30.

The method further comprises a step (d) of interchanging the picture frame 30 with a new picture frame 30 by the steps of:

(d.1) detaching the detachable face from the electronic game device 70;

(d.2) detaching the see-through protective shelter 20 from the detachable frame 10 for allowing the picture frame 30 to be accessed;

(d.3) replacing the picture frame 30 to the new picture frame 30;

(d.4) attaching the see-through protective shelter 20 back to the detachable frame 10 to retain the new picture frame 30 within the picture compartment 21; and

(d.5) attaching the detachable face back to the electronic game device 70 to create a visual effect of the electronic game device 70 via the new picture frame 30.

Again, the picture frame 30 may be pre-cut into a size and shape corresponding to the detachable frame 10 to fit into the picture compartment 21.

The method further comprises a step of providing background illumination to the picture frame 30 to highlight the picture frame 30 so as to enhance the aesthetic appearance of the picture frame 30. The illumination is provided by the lighting arrangement 40 of the detachable face.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A detachable face for an electronic game device having an engaging side, comprising:
a detachable frame having a coupling side adapted for detachably coupling with said engaging side of said electronic game device, and an opposed picture retention side adapted for holding a picture frame in position; and
a see-through protective shelter detachably mounted at said picture retention side of said detachable frame to form a picture compartment between said protective shelter and said detachable frame for receiving said picture frame so as to allow said picture frame from being seen through said protective shelter, in such a manner that said detachable face is adapted for creating a visual effect of said electronic game via said picture frame as a decorative element and for enhancing an aesthetic appearance of said electronic game device by selectively interchanging said picture frame.

2. The detachable face, as recited in claim 1, wherein said detachable frame further has an engagement rim indently formed on said picture retention side of said detachable frame to define a retention cavity on said picture retention side, wherein said see-through protective shelter is detachably mounted on said picture retention side of said detachable frame to enclose said retention cavity for sealing said picture frame therein.

3. The detachable face, as recited in claim 2, further having a plurality of through accessing slots respectively formed on the detachable frame and said see-through protective shelter at a predetermined position that said accessing slots are respectively aligned with operation elements on said engaging side of said electronic game device for allowing a user accessing said operation elements of said electronic game device when said detachable face is mounted thereto.

4. The detachable face, as recited in claim 3, wherein said detachable frame further comprises at least one engaging member rearwardly extended from said coupling side of said detachable frame for mounting on said engaging side of said electronic game device so as to mount said picture frame on said electronic game device.

5. The detachable face, as recited in claim 1, further comprising a lighting arrangement which comprises at least one illuminating unit mounted within said picture compartment at a position behind said picture frame for providing background illumination to said picture frame to highlight said picture frame so as to enhance said aesthetic appearance of said picture frame.

6. The detachable face, as recited in claim 4, further comprising a lighting arrangement which comprises at least one illuminating unit mounted within said picture compartment at a position behind said picture frame for providing background illumination to said picture frame to highlight said picture frame so as to enhance said 10 aesthetic appearance of said picture frame.

7. The detachable face, as recited in claim 3, further comprising a frame guider shaped and sized corresponding to said detachable frame for guiding a user to cut said picture frame into a desirable size with respect to said detachable frame, wherein said frame guider has a plurality of guiding slots aligning with said accessing slots respectively for guiding said user to form a plurality of through slots on said picture frame so as to incorporate said picture frame with said detachable face.

8. The detachable face, as recited in claim 6, further comprising a frame guider shaped and sized corresponding to said detachable frame for guiding a user to cut said picture frame into a desirable size with respect to said detachable frame, wherein said frame guider has a plurality of guiding slots aligning with said accessing slots respectively for guiding said user to form a plurality of through slots on said picture frame so as to incorporate said picture frame with said detachable face.

9. A detachable face for an electronic game device having an engaging side, comprising:
a plurality of picture frames;
a detachable frame having a coupling side adapted for detachably coupling with said engaging side of said electronic game device, and an opposed picture retention side to hold one of said picture frames in position; and
a see-through protective shelter detachably mounted at said picture retention side of said detachable frame to form a picture compartment between said protective shelter and said detachable frame to receive said picture frame so as to allow said picture frame from being seen through said protective shelter, in such a manner that said detachable face is adapted for creating a visual effect of said electronic game via said picture frame as a decorative element and for enhancing an aesthetic appearance of said electronic game device by selectively interchanging said picture frame.

10. The detachable face, as recited in claim 9, wherein said detachable frame further has an engagement rim indently formed on said picture retention side of said detachable frame to define a retention cavity on said picture retention side, wherein said see-through protective shelter is detachably mounted on said picture retention side of said detachable frame to enclose said retention cavity for sealing said picture frame therein.

11. The detachable face, as recited in claim 10, further having a plurality of through accessing slots respectively formed on the detachable frame and said see-through protective shelter at a predetermined position that said accessing slots are respectively aligned with operation elements on said engaging side of said electronic game device for allowing a user accessing said operation elements of said electronic game device when said detachable face is mounted thereto.

12. The detachable face, as recited in claim 11, wherein said detachable frame further comprises at least one engaging member rearwardly extended from said coupling side of said detachable frame for mounting on said engaging side of said electronic game device so as to mount said picture frame on said electronic game device.

13. The detachable face, as recited in claim 9, further comprising a lighting arrangement which comprises at least one illuminating unit mounted within said picture compartment at a position behind said picture frame for providing background illumination to said picture frame to highlight said picture frame so as to enhance said aesthetic appearance of said picture frame.

14. The detachable face, as recited in claim 12, further comprising a lighting arrangement which comprises at least one illuminating unit mounted within said picture compartment at a position behind said picture frame for providing background illumination to said picture frame to highlight said picture frame so as to enhance said aesthetic appearance of said picture frame.

15. The detachable face, as recited in claim 11, wherein each of said picture frames is pre-cut into a size and shape corresponding to said detachable frame to fit into said picture compartment, wherein each of said picture frames has a plurality of through slots aligning with said accessing slots respectively for allowing said user accessing said operation elements of said electronic game device when said detachable face is mounted thereto.

16. The detachable face, as recited in claim 14, wherein each of said picture frames is pre-cut into a size and shape corresponding to said detachable frame to fit into said picture compartment, wherein each of said picture frames has a plurality of through slots aligning with said accessing slots respectively for allowing said user accessing said operation elements of said electronic game device when said detachable face is mounted thereto.

17. A method of displaying a picture frame on an electronic game device having an engaging side, comprising the steps of:
(a) detachably disposing said picture frame in a detachable frame, wherein said detachable frame has a coupling side adapted for detachably coupling with said engaging side of said electronic game device and an opposed picture retention side adapted for holding said picture frame in position;
(b) detachably attaching a see-through protective shelter on said picture retention side of said detachable frame to form a detachable face, wherein a picture compartment is formed between said protective shelter and said detachable frame to sealedly receive said picture frame in said picture compartment so as to allow said picture frame from being seen through said protective shelter; and
(c) detachably attaching said coupling side of said detachable face on said engaging side of said electronic game device, in such a manner that said detachable face is adapted for creating a visual effect of said electronic game device via said picture frame as a decorative element and for enhancing an aesthetic appearance of said electronic game device by selectively interchanging said picture frame.

18. The method, as recited in claim 17, further comprising a step of:
(d) interchanging said picture frame with a new picture frame by the steps of:
(d.1) detaching said detachable face from said electronic game device;
(d.2) detaching said see-through protective shelter from said detachable frame for allowing said picture frame to be accessed;
(d.3) replacing said picture frame to said new picture frame;
(d.4) attaching said see-through protective shelter back to said detachable frame to retain said new picture frame within said picture compartment; and
(d.5) attaching said detachable face back to said electronic game device to create a visual effect of said electronic game device via said new picture frame.

19. The method, as recited in claim 18, wherein said picture frame is pre-cut into a size and shape corresponding to said detachable frame to fit into said picture compartment.

20. The method, as recited in claim 19, further comprising a step of providing background illumination to said picture frame to highlight said picture frame so as to enhance said aesthetic appearance of said picture frame.
